(19) United States
(12) Patent Application Publication
(10) Pub. No.: US 2025/0030093 A1
(43) Pub. Date: Jan. 23, 2025

(54) CASE FOR LITHIUM RECHARGEABLE BATTERY AND LITHIUM RECHARGEABLE BATTERY INCLUDING THE SAME

(71) Applicant: Samsung SDI Co., Ltd., Yongin-si (KR)

(72) Inventors: Juyun KIM, Yongin-si (KR); Jaehwan HA, Yongin-si (KR); Yujin KANG, Yongin-si (KR); Dongho KOO, Yongin-si (KR)

(21) Appl. No.: 18/657,877

(22) Filed: May 8, 2024

(30) Foreign Application Priority Data
Jul. 21, 2023 (KR) 10-2023-0095522
Jul. 21, 2023 (KR) 10-2023-0095523

(51) Int. Cl. H01M 50/129; H01M 10/052; H01M 10/0585; H01M 50/105; H01M 50/121; H01M 50/124; H01M 50/126; H01M 50/133

(52) U.S. Cl. CPC H01M 50/129; H01M 10/052; H01M 10/0585; H01M 50/105; H01M 50/121; H01M 50/1243; H01M 50/1245; H01M 50/126; H01M 50/133

(57) ABSTRACT

A case for a rechargeable lithium battery, the case for the rechargeable lithium battery including a laminate sheet in which an inner layer, a middle layer, and an outer layer are sequentially laminated; and a first polymer film on the outer layer of the laminate sheet and including a first polyurethane resin.

### CROSS-REFERENCE TO RELATED APPLICATION

This application claims priority to and the benefit of Korean Patent Application No. 10-2023-0095522 filed in the Korean Intellectual Property Office on Jul. 21, 2023, and Korean Patent Application No. 10-2023-0095523 filed in the Korean Intellectual Property Office on Jul. 21, 2023, the entire contents of which are incorporated herein by reference.

### BACKGROUND

### 1. Field

Embodiments relate to a case for a rechargeable lithium battery and a rechargeable lithium battery including the same.

### 2. Description of the Related Art

A rechargeable lithium battery may be recharged and may have three or more times as high energy density per unit weight as a conventional lead storage battery, a nickel-cadmium battery, a nickel hydrogen battery, a nickel zinc battery and the like. It may be also charged at a high rate and thus, it may be commercially manufactured for a laptop, a cell phone, an electric tool, an electric bike, and the like, and research on improvements, e.g., additional energy density, have been actively made.

### SUMMARY

Embodiments are directed a case for a rechargeable lithium battery, the case including a laminate sheet in which an inner layer, a middle layer, and an outer layer are sequentially laminated; and a first polymer film on the outer layer of the laminate sheet, the first polymer film including a first polyurethane resin.

The case may further include a second polymer film on the inner layer of the laminate sheet, the second polymer film including a second polyurethane resin.

The first polymer film may have a friction coefficient of about 0.4μ to about 0.8μ.

The first polymer film and the second polymer film may each independently have a friction coefficient of about 0.4μ to about 0.8μ.

The first polymer film may have an elongation rate of about 200% to about 700%.

The first polymer film and the second polymer film may each independently have an elongation rate of about 200% to about 700%.

The first polymer film may have a tensile strength of about 250 kgf/mm² to about 600 kgf/mm².

The first polymer film and the second polymer film may each independently have a tensile strength of about 250 kgf/mm² to about 600 kgf/mm².

The first polymer film may have a thickness of about 10 μm to about 300 μm.

The first polymer film and the second polymer film may each independently have a thickness of about 10 μm to about 300 μm.

The first polyurethane resin may have a weight average molecular weight of about 10,000 g/mol to about 3,000,000 g/mol.

The first polyurethane resin and the second polyurethane resin may each independently have a weight average molecular weight of about 10,000 g/mol to about 3,000,000 g/mol.

A method of forming a case for a rechargeable lithium battery, the method including supplying a laminate sheet in which an inner layer, a middle layer, and an outer layer are sequentially laminated; and forming a polymer film manufactured from a composition for a polymer film including a urethane binder, a curing agent, and a plasticizer on the outer layer of the laminate sheet.

A second polymer film manufactured from the composition for a polymer film may be formed on the inner layer of the laminate sheet.

The composition for the polymer film may include about 1 part to about 30 parts by weight of the plasticizer based on 100 parts by weight of the urethane binder.

The plasticizer may include isopropyl myristate, isopropyl palmitate, isotridecyl isononanoate, 1,2-cyclohexanedicarboxylic acid diisononyl ester, isostearyl palmitate, isostearyl laurate, diisostearyl adipate, diisocetyl sebacate, or a combination thereof.

The urethane binder may be prepared by polymerizing about 1 to about 10 parts by weight of an isocyanate compound based on 100 parts by weight of a polyol, including about 50 wt % to about 90 wt % of polyether triol, about 5 wt % to about 40 wt % of polyether diol, and about 5 wt % to about 40 wt % of polyester diol.

The composition for the polymer film may further include a leveling agent, an antistatic agent, an antioxidant, a catalyst, a retarder, or a combination thereof.

The case may be a pouch-type case.

The embodiments may be realized by providing a rechargeable lithium battery, including the case; and an electrode assembly housed in the case.

The embodiments may be realized by providing a rechargeable lithium battery, including the case of claim 2; and an electrode assembly housed in the case.

The rechargeable lithium battery may be an all-solid battery, a semi-solid battery, a lithium metal battery, or a lithium ion battery.

The the rechargeable lithium battery may be an all-solid-state battery, and a heat generation amount may be about 100 J/g to about 1,000 J/g if subjected to a nail penetration test under conditions of SOC of 100%, a nail diameter of 3 mm, and a penetration speed of 25 mm/sec.

### BRIEF DESCRIPTION OF THE DRAWINGS

Features will become apparent to those of skill in the art by describing in detail exemplary embodiments with reference to the attached drawings in which:

FIG. 1 is a cross-sectional view schematically showing a nail penetration test of a rechargeable lithium battery using a comparative case for a rechargeable lithium battery;

FIGS. 2 and 3 are cross-sectional views schematically showing a nail penetration test of a rechargeable lithium battery using a case for a rechargeable lithium battery according to some embodiments; and

FIGS. 4 and 5 are cross-sectional views schematically showing an all-solid-state battery according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, the singular may also include the plural. In addition, unless otherwise specified, “A or B” may mean “including A, including B, or including A and B.”

As used herein, “combination thereof” may mean a mixture of constituents, a stack, a composite, a copolymer, an alloy, a blend, and a reaction product.

As used herein, when a definition is not otherwise provided, a particle diameter may be an average particle diameter. This average particle diameter means an average particle diameter (D50), which is a diameter of particles with a cumulative volume of 50 volume % in the particle size distribution. The average particle diameter (D50) can be measured by suitable methods, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle diameter (D50) based on 50% of the particle size distribution in the measuring device can be calculated.

As used herein, “weight average molecular weight” is a value measured by gel permeation chromatography (GPC, PL GPC220, Agilent Technologies) and corrected with a cubic function using polystyrene.

### Case for Rechargeable Lithium Battery

Some embodiments provide a case for a rechargeable lithium battery including a laminate sheet in which an inner layer, a middle layer, and an outer layer may be sequentially laminated; and a first polymer film disposed on the outer layer of the laminate sheet and including a first polyurethane resin.

The case for the rechargeable lithium battery according to some embodiments may further include a second polymer film on the inner layer of the laminate sheet including a second polyurethane resin.

The case for a rechargeable lithium battery according to some embodiments may ensure the safety of the rechargeable lithium battery by suppressing short circuits and heat generation even if metal foreign substances, etc. penetrate the inside of the battery from the outside.

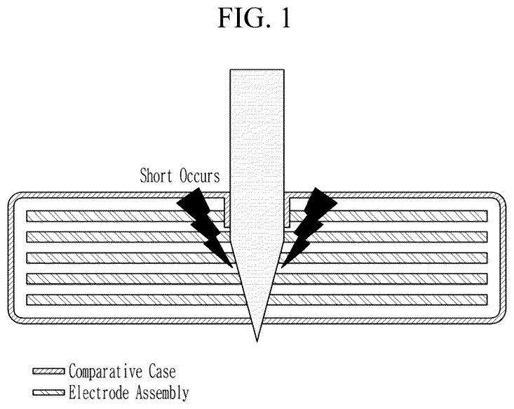

FIG. 1 is a cross-sectional view schematically showing a nail penetration test of a rechargeable lithium battery using a comparative case for a rechargeable lithium battery.

A comparative rechargeable lithium battery case may consist of only a laminate sheet in which an inner layer, a middle layer, and an outer layer may be sequentially stacked, and the outer layer may be exposed to the outside.

However, the outer layer may be made of materials with low friction, e.g., polyethylene terephthalate (PET), polyethylene naphthalate (PEN), or nylon. Accordingly, if a nail penetrates from the outside of a comparative case for a rechargeable lithium battery, the outer layer cannot be stretched beyond a certain level and may be cut. As a result, the nail breaking through the outer layer may form a direct conductive path between the positive electrode and the negative electrode.

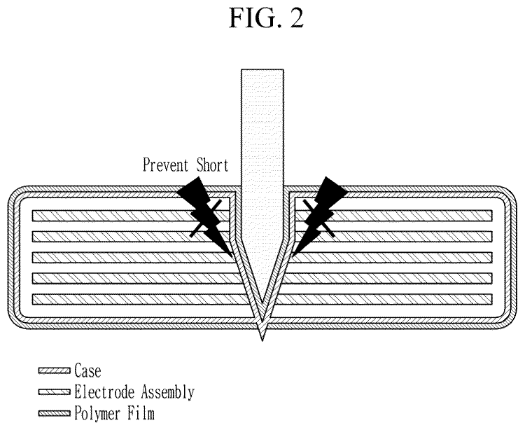

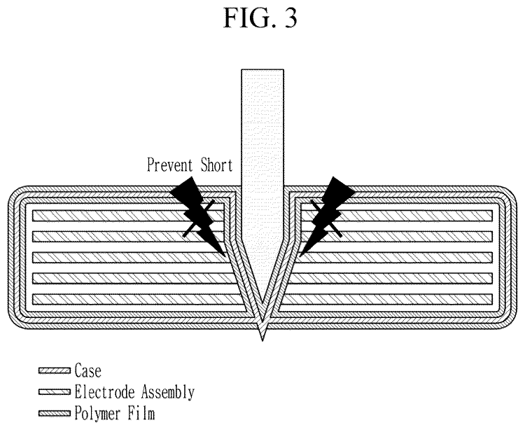

FIGS. 2 and 3 are cross-sectional views schematically showing a nail penetration test of a rechargeable lithium battery using a case of some embodiments.

The case for a rechargeable lithium battery according to some embodiments may further include a first polymer film on the outer layer of a case for a rechargeable lithium battery, and the outer layer may be protected by the first polymer film.

In addition, the case for a rechargeable lithium battery according to some embodiments may further include a second polymer film on the inner layer of the case for a rechargeable lithium battery, so that the inner layer may be protected by the second polymer film.

The first polymer film and the second polymer film may each include polyurethane resin, which may be an insulating material with high friction, elongation rate, and tensile strength.

Accordingly, if a nail penetrates from the outside of the rechargeable lithium battery case of some embodiments, the first polymer film and the second polymer film may be stretched without being cut and may be pushed into the interior of the rechargeable lithium battery together with the nail, which may suppress the formation of a direct conductive path between the positive electrode and the negative electrode.

The synergistic effects resulting from the simultaneous presence of the first polymer film and the second polymer film may be higher compared to the effect of the first polymer film alone.

Hereinafter, a case for a rechargeable lithium battery of some embodiments will be described in detail.

### First Polymer Film and Second Polymer Film

In an implementation, the first polymer film and the second polymer film may each include polyurethane resin, which may be an insulating material with high friction, elongation rate, and tensile strength.

### Weight Average Molecular Weight

The first polyurethane resin and the second polyurethane resin may each independently have a weight average molecular weight measured by GPC of about 10,000 g/mol to about 3,000,000 g/mol, e.g., about 20,000 g/mol to about 2,000,000 g/mol or about 70,000 to about 100,000 g/mol. In these ranges, a first polymer film and a second polymer film having an appropriate friction coefficient may be formed.

### Friction Coefficient

The first polymer film and the second polymer film may each independently have a friction coefficient of about 0.4μ to about 0.8μ. In this range, the first polymer film and the second polymer film may each provide a large frictional force that may push the metal foreign substance together, so that the aforementioned effect may be excellently achieved.

The friction coefficient may be measured by a suitable static friction coefficient measurement method. For example, by using equipment that measures the static friction coefficient, by increasing an angle of a slope to calculate and measure the stress at the point where an object begins to move.

### Elongation Rate

The first polymer film and the second polymer film may each independently have an elongation rate according to the ASTM D638 measurement method of about 200% to about 700%, e.g., about 200% to about 650%, about 400% to about 650%. In these ranges, the first polymer film and the second polymer film may each be able to be sufficiently stretched so that they may be pushed in together with the metal foreign substances, so that the aforementioned effect can be excellently exhibited.

### Tensile Strength

The first polymer film and the second polymer film may each independently have a tensile strength according to the ISO 527 measurement method of about 250 kgf/mm² to about 600 kgf/mm², e.g., about 300 kgf/mm² to about 500 kgf/mm² or about 330 kgf/mm² to about 450 kgf/mm². Within these ranges, the first polymer film and the second polymer film may not be cut by metal foreign substances, and the above effects may be excellently exhibited.

### Thickness

The first polymer film and the second polymer film may each independently have a thickness of about 10 μm to about 300 μm, e.g., about 50 μm to about 300 μm or about 100 μm to about 250 μm. In these ranges, the respective thicknesses of the first polymer film and the second polymer film that may be pushed together with the metal foreign substance may be sufficiently secured, so that the aforementioned effect may be excellently exhibited.

The thickness may be measured by a digital thickness gauge (MIYUTOYO).

### Manufacturing Method of Polymer Film

The first polymer film and the second polymer film may each independently be manufactured from a composition for a polymer film including a polyurethane resin.

The composition for the polymer film may be manufactured from a composition for a polymer film including a urethane binder, a curing agent, and a plasticizer.

### Urethane Binder

The urethane binder may be cured by the curing agent to form the polyurethane resin.

The urethane binder may have one or more urethane bonds and one or more hydroxyl groups (—OH). The urethane binder may be included in an amount of 60 wt % to 100 wt %, based on a total weight of the urethane binder.

The urethane binder may have a number average molecular weight of about 30,000 g/mol to about 150,000 g/mol, e.g., about 50,000 g/mol to about 70,000 g/mol.

The urethane binder may include one or more polyols; and one or more isocyanate compounds.

In an implementation, the urethane binder may be prepared by polymerizing an isocyanate compound based on 100 parts by weight of polyol including polyether triol, polyether diol, and polyester diol. Herein, the polymerization method may be thermal polymerization.

The polyol may include, e.g., polyether polyol, polyester polyol, polyacrylic polyol, polycaprolactone polyol, or polycarbonate polyol. In an implementation, the polyol may include one or more types of polyether polyols and may further include one or more types of polyester polyols.

In an implementation, the urethane binder may be a random copolymer having units derived from the polyol. In an implementation, the urethane binder may include a unit derived from polyether polyol and may further include a unit derived from polyester polyol.

The polyether polyol may have an alkylene oxide group and may be bifunctional polyether polyol (polyether diol) or tri-functional polyether polyol (polyether triol), e.g., polyethylene glycol, polypropylene glycol, or polytetramethylene ether glycol, polyether polyols having two or more hydroxyl groups, including trifunctional polyether polyols of glycerin alkylene oxide adducts (polyether triol), etc. Through this, the urethane binder may become a hyperbranched binder, making it easier to implement the effect of the present disclosure by having a more structured structure than a linear form of the urethane binder. The ‘hyper branched type’ may refer to a polymer that has many terminal functional groups and has a dendrite-type branched structure.

The polyether polyol used if preparing a urethane binder may include one type of polyether polyol or two or more types of polyether polyols. In an implementation, the polyether polyol may include a mixture of polyether diol and polyether triol.

The polyether polyol may have a number average molecular weight of about 400 g/mol to about 10,000 g/mol, e.g., about 1,000 g/mol to about 7,000 g/mol. In an implementation, the polyether triol may have a number average molecular weight of about 400 g/mol to about 10,000 g/mol, e.g., about 2,000 g/mol to about 8,000 g/mol. In an implementation, the polyether diol may have a number average molecular weight of about 400 g/mol to about 10,000 g/mol, e.g., about 1,000 g/mol to about 6,000 g/mol.

The polyester polyol may include a polyol obtained by an esterification reaction between one or more polyols and one or more acid components.

In an implementation, the polyols used may include, e.g., ethylene glycol, propylene glycol, diethylene glycol, 1,3-butanediol, 1,4-butanediol, neopentyl glycol, 3-methyl-1,5-pentanediol, 2-butyl-2-ethyl-1,3-propanediol, 2,4-diethyl-1,5-pentanediol, 1,2-hexanediol, 1,6-hexanediol, 2-ethyl-1,3-hexanediol, 1,8-octanediol, 1,9-nonanediol, 2-methyl-1,8-octanediol, 1,8-decanediol, octadecane diol, glycerin, trimethylolpropane, pentaerythritol, and hexanetriol. The acid components used may be, e.g., succinic acid, methylsuccinic acid, adipic acid, azelaic acid, sebacic acid, 1,12-dodecanedioic acid, 1,14-tetradecandioic acid, dimeric acid, 2-methyl-1,4-cyclohexanedicarboxylic acid, 2-ethyl-1,4-cyclohexanedicarboxylic acid, terephthalic acid, isophthalic acid, phthalic acid, 1,4-naphthalenedicarboxylic acid, 4,4′-biphenyldicarboxylic acid, or acid anhydrides thereof.

The polyester polyol used if preparing a urethane binder may include one type of polyester polyol or two or more types of polyester polyols.

The polyester polyol may include a polyester polyol having two or more hydroxyl groups, including, e.g., a bifunctional polyester polyol or a trifunctional polyester polyol (polyester triol). Through this, the urethane binder may become a hyper-branched binder, making it easier to implement the effect of the present disclosure. In an implementation, polyester diol may be used as the polyester polyol.

The polyester diol may have a number average molecular weight of about 1,000 g/mol to about 5,000 g/mol, e.g., about 2,000 g/mol to about 3,000 g/mol. Within these ranges, it may be easier to reach the peeling force and modulus necessary to implement the effect of the present disclosure.

The isocyanate compound may include a polyisocyanate compound having a plurality of isocyanate groups (—NCO). The polyisocyanate compound may be a known polyisocyanate compound, and may include, e.g., aliphatic polyisocyanate, cycloaliphatic polyisocyanate, aromatic polyisocyanate, and aromatic aliphatic polyisocyanate compounds. In an implementation, an aliphatic polyisocyanate compound may be used.

The aliphatic polyisocyanate compound may include, e.g., hexamethylene diisocyanate, trimethylene diisocyanate, tetramethylene diisocyanate, pentamethylene diisocyanate, 1,2-propylenediisocyanate, 2,3-butylenediisocyanate, 1,3-butylenediisocyanate, dodecamethylene diisocyanate, and 2,4,4-trimethylhexamethylenediisocyanate.

In an implementation, the urethane binder may be prepared by polymerizing about 1 part to about 10 parts by weight of the isocyanate compound based on 100 parts by weight of a polyol including about 50 wt % to about 90 wt % of polyether triol, about 5 wt % to about 40 wt % of polyether diol, and about 5 wt % to about 40 wt % of polyester diol based on a total weight of the polyol.

In an implementation, the polymerization may be performed by adding a catalyst to a mixture including one or more polyols and one or more polyisocyanate compounds and then reacting the mixture at a predetermined temperature.

The catalyst may include, e.g., dibutyl tin dilaurate (DBTDL), tin 2-ethylhexanoate, etc. as a tin compound.

The urethane binder may be prepared by placing a polyol mixture in a reactor and polymerizing it at about 50° C. to about 100° C. for about 3 hours to about 7 hours under nitrogen purging.

### Curing Agent

The curing agent may produce a polyurethane resin by curing the urethane binder.

The curing agent may react with a urethane binder by having one or more isocyanate groups (—NCO).

The isocyanate curing agent may be a polyfunctional isocyanate curing agent having a plurality of isocyanate groups and may include a suitable common isocyanate curing agent.

The isocyanate curing agent may include, e.g., aliphatic isocyanate, cycloaliphatic isocyanate, aromatic isocyanate, and aromatic aliphatic isocyanate compounds, or polyol adducts thereof, biurets thereof, or isocyanurates thereof. In an implementation, the aliphatic isocyanate compound may include, e.g., hexamethylene diisocyanate, trimethylene diisocyanate, tetramethylene diisocyanate, pentamethylene diisocyanate, 1,2-propylene diisocyanate, 2,3-butylene diisocyanate, 1,3-butylene diisocyanate, dodecamethylene diisocyanate, or 2,4,4-trimethylhexamethylene diisocyanate. In an implementation, the aromatic isocyanate compound may include, e.g., toluene diisocyanate, xylylene diisocyanate, or phenylene diisocyanate.

The curing agent may be used in an amount of about 1 part to about 10 parts by weight, based on 100 parts by weight of the urethane binder, e.g., about 2 parts to about 6 parts by weight.

### Plasticizer

The plasticizer may be an additive that reduces the viscosity or plasticity of a material. The plasticizer may be used in an amount of about 1 part to about 30 parts by weight, based on 100 parts by weight of the urethane binder, e.g., about 5 parts to about 30 parts by weight or about 10 parts to about 30 parts by weight, based on 100 parts by weight of the urethane binder. Within the above ranges, as the content of the plasticizer increases, the friction coefficient of the polymer film may increase.

The plasticizer may be isopropyl myristate, isopropyl palmitate, isotridecyl isononanoate, 1,2-cyclohexane dicarboxylic acid diisononyl ester, isostearyl palmitate, isostearyl laurate, diisostearyl adipate, diisocetyl sebacate, or a combination thereof.

### Other Additives

The composition for the polymer film may further include a leveling agent, an antistatic agent, an antioxidant, a catalyst, a retarder, or a combination thereof.

The leveling agent may improve the leveling properties of the polymer film. The leveling agent may include an acrylic leveling agent, a fluorine leveling agent, a silicone leveling agent, a silicone-acrylate leveling agent, etc.

The leveling agent may be used in an amount of about 0.1 to about 5 parts by weight, based on 100 parts by weight of the urethane binder, e.g., about 0.2 parts to about 1 part by weight, based on 100 parts by weight of the urethane binder.

The antistatic agent may prevent damage to the adherend by suppressing the generation of static electricity during the process of peeling off the polymer film after attaching it to the adherend. The antistatic agents may include suitable antistatic agents. In an implementation, the antistatic agent may include ionic liquids.

The antistatic agent may be used in an amount of about 0.01 parts to about 5 parts by weight, based on 100 parts by weight of the urethane binder, e.g., about 0.02 parts to about 1 part by weight, based on 100 parts by weight of the urethane binder.

The antioxidant may block the influence of the adhesive film on the external environment and prevent unraveling of the adhesive film, thus ensuring the intended peeling force. The antioxidant may include suitable antioxidants. In an implementation, the antioxidant may include cinnamate, phenol, sulfur, phosphorus, or HALS compounds, etc.

The antioxidant may be used in an amount of about 0.01 parts to about 5 parts by weight, based on 100 parts by weight of the urethane binder, e.g., about 0.02 parts to about 1 part by weight, based on 100 parts by weight of the urethane binder.

The catalyst may be a reaction catalyst for a reaction between a urethane binder and a curing agent. The catalyst may include one or more types of metal catalysts. The metal catalyst may include, e.g., a tin catalyst and a non-tin catalyst. As the tin catalyst and the non-tin catalyst, suitable types may be used. In an implementation, the tin catalyst may include, e.g., dibutyl tin dichloride, dibutyl tin oxide, dibutyl tin dilaurate, dibutyl tin sulfide, dibutyl tin diacetate, dibutyl tin maleate, etc.

The catalyst may be used in an amount of about 0.005 parts to about 0.5 parts by weight, based on 100 parts by weight of the urethane binder, e.g., about 0.01 parts to about 0.1 parts by weight, based on 100 parts by weight of the urethane binder.

The retarder may include suitable retarders. In an implementation, the retarder may include, e.g., acetyl acetone or a complex thereof. The retarder may be used in an amount of about 0.01 parts to about 5 parts by weight, based on 100 parts by weight of the urethane binder, e.g., about 1.5 parts to about 3 parts by weight, based on 100 parts by weight of the urethane binder.

### Laminate Sheet

The laminate sheet may have the same structure as the case for a lithium rechargeable battery described above. In an implementation, the laminate sheet may have a structure in which an inner layer, a middle layer, and an outer layer are sequentially laminated. The outer layer may include a polymer to protect the electrode assembly from the external environment. In an implementation, the outer layer may include, e.g., polyethylene terephthalate (PET), polyethylene naphthalate (PEN), nylon, or a combination thereof. The middle layer may include a metal layer that may improve the strength of the case and prevents the inflow and outflow of gas. In an implementation, the middle layer may include, e.g., aluminum (Al), iron (Fe), copper (Cu), tin (Sn), nickel (Ni), cobalt (Co), silver (Ag), stainless steel, carbon (C), chromium (Cr), manganese (Mn), titanium (Ti), or a combination thereof.

The inner layer may include a polymer that suppresses outflow of electrolyte and has heat-sealability. In an implementation, the outer layer may include polyolefin resin. In an implementation, the outer layer may include, e.g., polypropylene (PP) resin. The lamination sheet may further include an adhesive layer between different layers.

### Pouch-Type Case

The case for a lithium rechargeable battery in some embodiments may be a pouch-type case, and the safety of the pouch-type case can be improved by applying the polymer film.

### Rechargeable Lithium Battery

Some embodiments may provide a rechargeable lithium battery including the case for a rechargeable lithium battery of the aforementioned embodiment; and an electrode assembly housed in the case for the rechargeable lithium battery.

The rechargeable lithium battery to which the rechargeable lithium battery case may be applied may be, e.g., an all-solid battery, a semi-solid battery, a lithium metal battery, or a lithium ion battery.

### Nail Penetration Test of All-Solid-State Battery

The rechargeable lithium battery to which the case for the rechargeable lithium battery may be applied may be an all-solid-state battery, and if subjected to a nail penetration test under the conditions of SOC of 100%, a nail diameter of 3 mm, and a penetration speed of 25 mm/sec, a heat generation amount may be, e.g., about 100 J/g to about 1,000 J/g, about 200 J/g to about 800 J/g, or about 300 J/g to about 750 J/mol. On the other hand, in the case of an all-solid-state battery using a comparative rechargeable lithium battery case, the heat generation amount could exceed 2,700 J/g if a nail penetration test were to be performed under the same conditions as above.

This effect may be the same not only for all-solid-state batteries but also for semi-solid batteries, lithium metal batteries, or lithium-ion batteries.

Therefore, the case for a rechargeable lithium battery according to some embodiments may ensure the safety of the rechargeable lithium battery by suppressing short circuits and heat generation even if metal foreign substances, etc. penetrate the inside of the battery from the outside.

### All-Solid-State Battery

In an implementation, the rechargeable lithium battery may be an all-solid-state battery. The all-solid-state battery may also be expressed as an all-solid rechargeable battery or an all-solid rechargeable lithium battery.

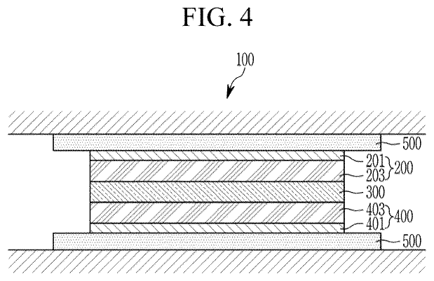

FIG. 4 is a cross-sectional view of an all-solid-state battery 100 according to some embodiments. Referring to FIG. 4, the all-solid-state battery 100 may include an electrode assembly in which a negative electrode 400 including a negative electrode current collector 401 and a negative electrode active material layer 403, a solid electrolyte layer 300, and a positive electrode 200 including a positive electrode active material layer 203 and a positive electrode current collector 201 may be stacked, wherein the electrode assembly may be housed in a case such as a pouch. The all-solid-state battery 100 may further include at least one elastic layer 500 on the outside of at least one of the positive electrode 200 and the negative electrode 400. Although FIG. 4 shows one electrode assembly including a negative electrode 400, a solid electrolyte layer 300, and a positive electrode 200, an all-solid-state battery may also be manufactured by stacking two or more electrode assemblies.

An all-solid-state battery according to some embodiments may be manufactured by preparing a stack by sequentially stacking a positive electrode, a solid electrolyte, and a negative electrode, and pressing the stack.

The pressing may be performed at a temperature of, e.g., about 25° C. to about 90° C., and may be performed at a pressure of about 550 MPa or less or about 500 MPa or less, e.g., about 400 MPa to about 500 MPa. The pressing may be, e.g., isostatic press, roll press or plate press.

The all-solid-state battery may be a unit cell having a structure of positive electrode/solid electrolyte layer/negative electrode, a bicell having a structure of positive electrode/solid electrolyte layer/negative electrode/solid electrolyte layer/positive electrode, or a stacked cell in which the structure of the unit cell is repeated.

The shape of the all-solid-state battery may be, e.g., coin-shaped, button-shaped, sheet-shaped, stacked-shaped, cylindrical, flat, etc. In an implementation, the all-solid-state battery may be applied to medium to large-sized batteries used in electric vehicles, etc. In an implementation, the all-solid-state battery may be used in hybrid vehicles such as plug-in hybrid electric vehicles (PHEV). In an implementation, the all-solid-state battery may be applied to an energy storage system (ESS) that requires large amounts of power storage, and may also be applied to electric bicycles or power tools.

### Positive Electrode Active Material

The positive electrode active material may be a compound (e.g., a lithiated intercalation compound) capable of intercalating and deintercalating lithium. In an implementation, one or more types of composite oxides of lithium and a metal, e.g., cobalt, manganese, nickel, and a combination thereof may be used.

The composite oxide may be a lithium transition metal composite oxide, e.g., lithium nickel oxide, lithium cobalt oxide, lithium manganese oxide, a lithium iron phosphate compound, cobalt-free lithium nickel-manganese oxide, or a combination thereof.

In an implementation, a compound represented by any of the following chemical formulae may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A may be, e.g., Ni, Co, Mn, or a combination thereof; X may be, e.g., Al, Ni, Co, Mn, Cr, Fe, Mg, Sr, V, a rare earth element, or a combination thereof; D may be, e.g., O, F, S, P, or a combination thereof; G may be, e.g., Al, Cr, Mn, Fe, Mg, La, Ce, Sr, V, or a combination thereof; and L¹ may be, e.g., Mn, Al or a combination thereof.

In an implementation, the positive electrode active material may have a nickel content of greater than or equal to about 80 mol %, greater than or equal to about 85 mol %, greater than or equal to about 90 mol %, greater than or equal to about 91 mol %, or greater than or equal to about 94 mol %, based on 100 mol % of metals excluding lithium in the lithium transition metal composite oxide. The positive electrode active electrode material may be a high nickel positive electrode active material having a nickel content of less than or equal to about 99 mol %, based on 100 mol % of metals excluding lithium in the lithium transition metal composite oxide. The high-nickel positive electrode active materials may achieve high capacity and may be applied to high-capacity, high-density rechargeable lithium batteries.

The positive electrode active material may include, e.g., lithium nickel oxide represented by Chemical Formula 11, lithium cobalt oxide represented by Chemical Formula 12, a lithium iron phosphate compound represented by Chemical Formula 13,and cobalt-free lithium nickel manganese oxide represented by Chemical Formula 14, or a combination thereof.

Liₐ₁Niₓ₁M¹_{y1}M²_{z1}O_{2-b1}X_{b1} [Chemical Formula 11]

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be, e.g., Al, B, Ba, Ca, Ce, Co, Cr, Cu, Fe, Mg, Mn, Mo, Nb, Si, Sn, Sr, Ti, V, W, or Zr, and X may be, e.g., F, P, or S.

In Chemical Formula 1, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} [Chemical Formula 12]

In Chemical Formula 12, 0.9≤a2≤1.8, 0.75≤x2≤1, 0≤y2≤0.3, 0.9≤x2+y2≤1.1, and 0≤b2≤0.1, M³ may be, e.g., Al, B, Ba, Ca, Ce, Cr, Cu, Fe, Mg, Mn, Mo, Ni, Se, Si, Sn, Sr, Ti, V, W, Y, Zn, or Zr, and X may be, e.g., F, P, or S.

Liₐ₃Feₓ₃M⁴_{y3}PO_{4-b3}X_{b3} [Chemical Formula 13]

In Chemical Formula 13, 0.9≤a3≤1.8, 0.6≤x3≤1, 0≤y3≤0.4, and 0≤b3≤0.1, M⁴ may be, e.g., Al, B, Ba, Ca, Ce, Co, Cr, Cu, Mg, Mn, Mo, Ni, Se, Si, Sn, Sr, Ti, V, W, Y, Zn, or Zr, and X may be, e.g., F, P, or S.

Liₐ₄Niₓ₄Mn_{y4}M⁵_{z4}O_{2-b4}X_{b4} [Chemical Formula 14]

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ may be, e.g., Al, B, Ba, Ca, Ce, Cr, Fe, Mg, Mo, Nb, Si, Sn, Sr, Ti, V, W, or Zr, and X may be, e.g., F, P, or S.

The average particle diameter (D50) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D50) of about 1 μm to about 9 μm and large particles having an average particle diameter (D50) of about 10 μm to about 25 μm. A positive electrode active material having particle sizes in these ranges may be harmoniously mixed with other components within the positive electrode active material layer and may achieve high capacity and high energy density. Herein, the average particle diameter may be obtained by selecting about 20 particles at random from a scanning electron microscope image of the positive electrode active material, measuring the particle diameter (diameter, major axis, or length of the major axis) to obtain a particle size distribution, and in the particle size distribution, taking the diameter (D50) of particles with a cumulative volume of 50 volume % as the average particle diameter.

The positive electrode active material may be in the form of secondary particles made by agglomerating a plurality of primary particles, or may be in the form of single particles. In an implementation, the positive electrode active material may have a spherical or close to spherical shape, or may have a polyhedral or irregular shape.

In an implementation, the positive electrode active material may include a buffer layer on the particle surface. The buffer layer may be expressed as a coating layer, a protective layer, etc., and may play a role in lowering the interface resistance between the positive electrode active material and the sulfide solid electrolyte particles. In an implementation, the buffer layer may include lithium-metal-oxide, where the metal may be, e.g., Al, B, Ca, Ce, Cr, Fe, Mg, Mo, Nb, Si, Sn, Sr, Ta, V, W, or Zr. The lithium-metal-oxide may improve the performance of the positive electrode active material by facilitating the movement of lithium ions and electronic conduction, and may be excellent for lowering the interfacial resistance between the positive electrode active material and solid electrolyte particles.

### Positive Electrode

A positive electrode for an all-solid-state battery may include a current collector and a positive electrode active material layer on the current collector, and the positive electrode active material layer may include a positive electrode active material and may optionally include a solid electrolyte, a binder, and/or a conductive material.

In an implementation, the positive electrode may further include an additive that may serve as a sacrificial positive electrode.

An amount of the positive electrode active material may be about 90 wt % to about 99.5 wt %, based on a total weight of the positive electrode active material layer, and amounts of the binder and the conductive material may be about 0.5 wt % to about 5 wt %, respectively, based on a total weight of the positive electrode active material layer.

The binder may attach the positive electrode active material particles well to each other and may also attach the positive electrode active material well to the current collector. In an implementation, the binder may be, e.g., polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, or a combination thereof.

The conductive material may be used to impart conductivity (e.g., electrical conductivity) to the electrode and any material that does not cause chemical change (e.g., does not cause an undesirable chemical change in the rechargeable lithium battery) and conducts electrons may be used in the battery. In an implementation, the conductive material may include a carbon material, e.g., natural graphite, artificial graphite, carbon black, acetylene black, Ketjen black, a carbon fiber, a carbon nanofiber, and carbon nanotube; a metal material including, e.g., copper, nickel, aluminum, silver, etc., in a form of a metal powder or a metal fiber; a conductive polymer, e.g., a polyphenylene derivative; or a mixture thereof.

The positive electrode active material layer may further include a solid electrolyte. The solid electrolyte may include, e.g. a sulfide solid electrolyte, an oxide solid electrolyte, a halide solid electrolyte, or a combination thereof.

Based on a total weight of the positive electrode active material layer, the solid electrolyte may be included in an amount of about 0.1 wt % to about 35 wt %, e.g., about 1 wt % to about 35 wt %, about 5 wt % to about 30 wt %, about 8 wt % to about 25 wt %, or about 10 wt % to about 20 wt % based on a total weight of the positive electrode active material layer.

The positive electrode active material layer may include, based on a total weight of the positive electrode active material and solid electrolyte, about 65 wt % to about 99 wt % of the positive electrode active material and about 1 wt % to about 35 wt % of the solid electrolyte, e.g., about 80 wt % to about 90 wt % of the positive electrode active material and about 10 wt % to about 20 wt % of solid electrolyte. If the solid electrolyte is included in the positive electrode at this amount, the efficiency and cycle-life characteristics of the all-solid-state rechargeable battery may be improved without reducing the capacity.

Al may be used as the current collector.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon negative electrode active material, e.g., crystalline carbon, amorphous carbon or a combination thereof. The crystalline carbon may be graphite such as irregular-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may include a Si negative electrode active material or a Sn negative electrode active material. The Si negative electrode active material may include silicon, a silicon-carbon composite, SiOₓ (0<x<2), a Si-Q alloy (wherein Q may be, e.g., an alkali metal, an alkaline-earth metal, a Group 13 element, a Group 14 element (excluding Si), a Group 15 element, a Group 16 element, a transition metal, a rare earth element, and a combination thereof). The Sn negative electrode active material may include Sn, SnO₂, a Sn alloy, or a combination thereof.

The silicon-carbon composite may be a composite of silicon and amorphous carbon. In an implementation, the silicon-carbon composite may be in a form of silicon particles and amorphous carbon coated on the surface of the silicon particles. In an implementation, the silicon-carbon composite may include a secondary particle (core) in which primary silicon particles are assembled, and an amorphous carbon coating layer (shell) on the surface of the secondary particle. The amorphous carbon may also be between the primary silicon particles, and, e.g., the primary silicon particles may be coated with the amorphous carbon. The secondary particle may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on a surface of the core.

The Si negative electrode active material or the Sn negative electrode active material may be used in combination with a carbon negative electrode active material.

### Negative Electrode

In an implementation, a negative electrode for an all-solid-state battery may include a current collector and a negative electrode active material layer on the current collector. The negative electrode active material layer may include a negative electrode active material and may further include a binder, a conductive material, or a solid electrolyte.

In an implementation, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may attach the negative electrode active material particles well to each other and also may attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

In an implementation, the aqueous binder may be used as the negative electrode binder, and it may further include a cellulose compound capable of imparting viscosity (e.g., thickener). The cellulose compound may include, e.g., carboxylmethyl cellulose, hydroxypropylmethyl cellulose, methyl cellulose, or alkali metal salts thereof. The alkali metal may be Na, K, or Li.

The dry binder may be a polymer material capable of being fiberized, and may be, e.g., polytetrafluoroethylene, polyvinylidene fluoride, polyvinylidene fluoride-hexafluoropropylene copolymer, polyethylene oxide, or a combination thereof.

The conductive material may provide electrode conductivity, and a suitable electrically conductive material may be used as a conductive material unless it causes a chemical change. Examples of the conductive material may be a carbon material such as natural graphite, artificial graphite, carbon black, acetylene black, Ketjen black, a carbon fiber, a carbon nanofiber, a carbon nanotube, or the like; a metal material such as copper, nickel, aluminum silver, or the like in a form of a metal powder or a metal fiber; a conductive polymer such as a polyphenylene derivative; or a mixture thereof.

The negative electrode current collector may include, e.g., copper foil, a nickel foil, a stainless steel foil, a titanium foil, a nickel foam, a copper foam, a polymer substrate coated with a conductive metal, and a combination thereof.

### Precipitation-Type Negative Electrode

In an implementation, the negative electrode for an all-solid-state battery may be a precipitation-type negative electrode. The precipitation-type negative electrode may be a negative electrode which includes no negative electrode active material during the assembly of a battery but in which a lithium metal and the like are precipitated during the charge of the battery and serve as a negative electrode active material.

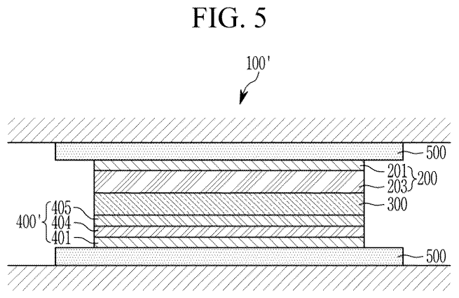

FIG. 5 is a schematic cross-sectional view of an all-solid-state battery 100′ including a precipitation-type negative electrode. Referring to FIG. 5, the precipitation-type negative electrode 400′ may include a current collector 401 and a negative electrode coating layer 405 on the current collector. The all-solid-state battery having this precipitation-type negative electrode 400′ may start to be initially charged in absence of a negative electrode active material, and a lithium metal with high density or the like may be precipitated between the current collector 401 and the negative electrode coating layer 405 during the charge and form a lithium metal layer 404, which may work as a negative electrode active material. Accordingly, the precipitation-type negative electrode 400′, in the all-solid-state battery which is more than once charged, may include the current collector 401, the lithium metal layer 404 on the current collector, and the negative electrode coating layer 405 on the lithium metal layer 404. The lithium metal layer 404 may mean a layer of the lithium metal and the like precipitated during the charge of the battery and may be called to be a metal layer, a negative electrode active material layer, or the like.

The negative electrode coating layer 405 may include metal or carbon material which may play a role of a catalyst.

The metal may include, e.g., gold, platinum, palladium, silicon silver, aluminum, bismuth, tin, zinc, or a combination thereof and may be composed of one selected therefrom or an alloy of more than one. The average particle diameter (D50) of the metal may be less than or equal to about 4 μm, e.g., about 10 nm to about 4 μm, about 10 nm to about 2 μm, or about 10 nm to about 1 μm.

The carbon material may be, e.g., crystalline carbon, non-graphitic carbon, or a combination thereof. In an implementation, the crystalline carbon may be, e.g., natural graphite, artificial graphite, mesophase carbon microbeads, and a combination thereof. The non-graphitic carbon may be, e.g., carbon black, activated carbon, acetylene black, Denka black, Ketjen black, furnace black, graphene, and a combination thereof.

If the negative electrode coating layer 405 includes both the metal and the carbon material, the mixing ratio of the metal and the carbon material may be, e.g., a weight ratio of about 1:10 to about 1:2, about 1:10 to about 2:1, about 5:1 to about 1:1, or about 4:1 to about 2:1. Herein, the precipitation of the lithium metal may be effectively promoted and improve characteristics of the all-solid-state battery. In an implementation, the negative electrode coating layer 405 may include a carbon material on which a catalyst metal may be supported, or may include a mixture of metal particles and carbon material particles.

The negative electrode coating layer 405 may further include a binder, and the binder may be, e.g., a conductive binder. In an implementation, the negative electrode coating layer 405 may further include general additives, e.g., a filler, a dispersing agent, or an ion conductive material.

A thickness of the negative electrode coating layer 405 may be, e.g., about 1 μm to about 20 μm, about 2 μm to about 10 μm, or about 3 μm to about 7 μm. In an implementation, the thickness of the negative electrode coating layer 405 may be about 50% or less, about 20% or less, or about 5% or less of the thickness of the positive electrode active material layer. If the thickness of the negative electrode coating layer 405 is too thin, it may be collapsed by the lithium metal layer 404, and if the thickness is too thick, the density of the all-solid-state battery may decrease and internal resistance may increase.

The precipitation-type negative electrode 400′ may further include a thin film, e.g., on the surface of the current collector, that is, between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and may help much improve characteristics of the all-solid-state battery. The thin film may be formed, e.g., in a vacuum deposition method, a sputtering method, a plating method, or the like. The thin film may have, e.g., a thickness of about 1 nm to about 800 nm, or about 100 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be, e.g., about 1 μm to about 500 μm, about 1 μm to about 200 μm, about 1 μm to about 100 μm, or about 1 μm to about 50 μm. If the thickness of the lithium metal layer 404 is too thin, it may be difficult to perform the role of a lithium storage, and if it is too thick, the battery volume may increase and performance may deteriorate.

If applying such a precipitation-type negative electrode, the negative electrode coating layer 405 may serve to protect the lithium metal layer 404 and suppress the precipitation growth of lithium dendrite. Accordingly, short circuits and capacity degradation of the all-solid-state battery may be suppressed and cycle-life characteristics may be improved.

### Solid Electrolyte Layer

The solid electrolyte layer may include a solid electrolyte.

The solid electrolyte may be a type of inorganic solid electrolyte, and may include, e.g., a sulfide solid electrolyte, an oxide solid electrolyte, a halide solid electrolyte, or a combination thereof.

### Sulfide Solid Electrolyte

The sulfide solid electrolyte may include, e.g., Li₂S—P₂S₅, Li₂S—P₂S₅—LiX (wherein X may be a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n may each be an integer, respectively, and Z may be, e.g., Ge, Zn or Ga), Li₂S—GeS₂, Li₂S—SiS₂—Li₃PO₄, Li₂S—SiS₂—LiₚMO_{q} (wherein p and q may each be an integer, and M may be, e.g., P, Si, Ge, B, Al, Ga, or In), or a combination thereof.

The sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio ranges, a sulfide solid electrolyte having excellent ionic conductivity may be prepared. The ionic conductivity may be further improved by adding SiS₂, GeS₂, B₂S₃, and the like as other components thereto.

Mechanical milling or a solution method may be applied as a mixing method of sulfur-containing raw materials for preparing a sulfide solid electrolyte. The mechanical milling may make starting materials into particulates by putting the starting materials in a ball mill reactor and vigorously stirring them. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. In an implementation, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some example embodiments may be prepared, e.g., through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ionic conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide solid electrolyte particle may have high ionic conductivity close to the range of about 10⁻⁴ to about 10⁻² S/cm, which is the ionic conductivity of general liquid electrolytes at ambient temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

In an implementation, the argyrodite-type sulfide solid electrolyte particles may include a compound represented by Chemical Formula 21.

(LiₐM¹_{b}M²_{c})(P_{d}M³ₑ)(S_{f}M⁴_{g})Xₕ [Chemical Formula 21]

In Chemical Formula 21, 4≤a≤8, M1 may be, e.g., Mg, Cu, Ag, or a combination thereof, 0≤b<0.5, M² may be, e.g., Na, K, or a combination thereof, 0≤c<0.5, M³ may be, e.g., Sn, Zn, Si, Sb, Ge, or a combination thereof, 0<d<4, 0≤e<1, M⁴ may be, e.g., O, SOₙ, or a combination thereof, 1.5≤n≤5, 3≤f≤12, 0≤g<2, X may be, e.g., F, Cl, Br, I, or a combination thereof, and 0≤h≤2.

In an implementation, in Chemical Formula 21, a halide element (X) may be necessarily included, and in this case, it may be expressed as 0<h≤2. In an implementation, the M¹ element may be necessarily included in Chemical Formula 21, and in this case, it may be expressed as 0<b<0.5. In Chemical Formula 21, M³ may be understood as an element substituted for P and may be 0<e<1. In Chemical Formula 21, M⁴ may be substituted for S and, e.g., may be 0<g<2, and f, a ratio of S, may be, e.g., 3≤f≤7. If M⁴ is SOₙ, SOₙ may be, e.g., S₄O₆, S₃O₆, S₂O₃, S₂O₄, S₂O₅, S₂O₆, S₂O₇, S₂O₈, SO₄, or SO₅, and, e.g., may be SO₄.

In an implementation, in Chemical Formula 21, a+b+c+h=7, d+e=1, and f+g+h=6.

In an implementation, the argyrodite-type sulfide solid electrolyte particles may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g. two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D50) of the sulfide solid electrolyte particles may be, e.g., about 0.1 μm to about 5.0 μm or about 0.1 μm to about 3.0 μm, and may be, e.g., small particles of about 0.1 μm to about 1.9 μm or, e.g., large particles of about 2.0 μm to about 5.0 μm. The sulfide solid electrolyte particles may be a mixture of elementary particles with an average particle diameter of, e.g., about 0.1 μm to about 1.9 μm and large particles with an average particle diameter of, e.g., about 2.0 μm to about 5.0 μm. The average particle diameter of the sulfide solid electrolyte particles may be measured using an electron microscope image, and, e.g., a particle size distribution may be obtained by measuring the size (diameter or long axis length) of about 20 particles in a scanning electron microscope image, and D50 may be calculated therefrom.

### Oxide Solid Electrolyte

The oxide solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb₂₃)O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M may be, e.g., Te, Nb, or Zr; x may be an integer of 1 to 10), or a mixture thereof.

### Halide Solid Electrolyte

The solid electrolyte layer may further include, e.g., a halide solid electrolyte. The halide solid electrolyte may include a halogen element as a main component, meaning that a ratio of the halide element to all elements constituting the solid electrolyte may be, e.g., about 50 mol % or more, about 70 mol % or more, about 90mol % or more, or about 100 mol %. In an implementation, the halide solid electrolyte may not include sulfur element.

The halide solid electrolyte may include a lithium element, a metal element other than lithium, and a halogen element. The metal element other than lithium may include, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be, e.g., F, Cl, Br, I, or a combination thereof, and in an implementation, it may be Cl, Br, or a combination thereof. The halide solid electrolyte may be, e.g., represented by LiₐM₁X₆ (M may be, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X, e.g., F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

### Binder

The solid electrolyte layer may further include a binder. The binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinyl fluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane resin, a copolymer thereof, or a combination thereof.

The binder may be included in an amount of, e.g., about 0.1 wt % to about 3 wt %, e.g., about 0.5 wt % to about 2 wt %, about 0.5 wt % to about 1.5 wt %, based on a total weight of the solid electrolyte layer. If the binder is included in the above range, the components in the solid electrolyte layer may be well combined without reducing the ionic conductivity of the solid electrolyte, thereby improving the durability and reliability of the battery.

### Other Components

The solid electrolyte layer may optionally further include an alkali metal salt or an ionic liquid or a conductive polymer.

The alkali metal salt may be, in an implementation, a lithium salt. A content of the lithium salt in the solid electrolyte layer may be greater than or equal to about 1 M, e.g., about 1 M to about 4 M. In this case, the lithium salt may improve ionic conductivity by improving lithium ion mobility of the solid electrolyte layer.

The lithium salt may be applied without type limitations, and may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro (oxalato)borate (LiDFOB), lithium difluorobis(oxalato)phosphate (LiDFBP), lithium bis(trifluoromethanesulfonyl)imide (LiTFSI), lithium bis(fluoro)sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may include an imide lithium salt such as LiTFSI, LiFSI, LiBETI, or a combination thereof. The imide lithium salt may maintain or improve ionic conductivity by appropriately maintaining chemical reactivity with the ionic liquid.

The ionic liquid may have a melting point below ambient temperature, so it may be in a liquid state at ambient temperature and may refer to a salt or ambient temperature molten salt composed of ions alone.

The ionic liquid may be a compound including at least one cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and at least one anion selected from, e.g., BF₄—, PF₆—, AsF₆—, SbF₆—, AlCl₄—, HSO₄—, ClO₄—, CH₃SO₃—, CF₃CO₂—, Cl—, Br—, I⁻, BF₄⁻, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be, e.g., N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer within the above ranges may maintain or improve ionic conductivity by improving the electrochemical contact area with the electrode. Accordingly, the energy density, discharge capacity, rate capability, etc. of the all-solid-state rechargeable battery may be improved.

The rechargeable lithium battery according to some embodiments may be applied to automobiles, mobile phones, or various types of electrical devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1-1

### (1) Preparation of Composition for Polymer Film

A urethane binder (a number average molecular weight: 6,013 g/mol±5%) was prepared by mixing 68 wt % of polyether triol (a solid content: 100%, a number average molecular weight: about 3,000 g/mol, PPG-3020, manufacturer: Kumho Petrochemical), 16 wt % of polyether-base diol (a solid content: 100%, a number average molecular weight: about 6,000 g/mol, PPG-6000, manufacturer: Kumho Petrochemical), and 16 wt % of polyester polyol (a number average molecular weight: 2,000 g/mol P-2010, manufacturer: Kuraray Co., Ltd.), adding 4 parts by weight of hexamethylene diisocyanate as an isocyanate compound to 100 parts by weight of the mixture, and thermally polymerizing them at 70° C. for 5 hours.

Based on 100 parts by weight of the obtained urethane binder, 4.5 parts by weight of coronate HX as a curing agent, 0.23 parts by weight of BYK-Silclean 3700 as a leveling agent, 10 parts by weight of isopropyl myristate as a plasticizer, 0.25 parts by weight of FC4400 as an antistatic agent, 0.25 parts by weight of Irganox 1010 as an antioxidant, 0.01 parts by weight of DBTDL as a catalyst, and 1.5 parts by weight of acetyl acetone as a retardant were mixed with methyl ethyl ketone (MEK) to prepare a composition for a polymer film.

### (2) Manufacturing of Case for Rechargeable Lithium Battery

A laminate sheet, in which an inner layer, a middle layer, and an outer layer were sequentially laminated (a pouch film, manufacturer: Dai Nippon Printing (DNP) Co., Ltd.) was prepared. The composition for a polymer film was cast to be 100 μm thick on the outer layer of the laminate sheet by using a slip casting method, dried at 130° C. for 4 minutes, and allowed to stand at 45° C. for 3 days. Accordingly, a case for a rechargeable lithium battery in which the first polymer film (a thickness: 100 μm) including a first polyurethane resin (a weight average molecular weight: 78,480 g/mol) was formed on the outer layer of the laminate sheet was obtained.

### (3) Preparation of Solid Electrolyte Layer

A binder solution was prepared by dissolving an acryl binder (SX-A334, Zeon Corp.) in an isobutyryl isobutyrate (IBIB) solvent, and an argyrodite solid electrolyte of Li₆PS₅Cl (D50-3 μm) was added thereto and then, stirred in a Thinky mixer to secure appropriate viscosity. After adjusting the viscosity, 2 mm zirconia balls were added thereto and then, stirred again with the Thinky mixer to prepare slurry. The slurry included 98 wt % of the solid electrolyte and 2 wt % of the binder. The slurry was coated on a release PET film with a bar coater and dried at room temperature to form a solid electrolyte layer.

### (4) Manufacture of Positive Electrode

85 wt % of LiNi_{0.9}Co_{0.05}Mn_{0.05}O₂ as a positive electrode active material, 13.5 wt % of Li₆PS₅Cl as a lithium argyrodite-type solid electrolyte, 1.0 wt % of polyvinylidene fluoride as a binder, and 0.5 wt % of carbon nanotube as a conductive material were prepared and then, added to dispersion media of octyl acetate (OA) and pentyl propionate (PPP) mixed in a weight ratio of 1:1. The obtained mixture was added to the Thinky mixer, and 2 mm zirconia balls were added thereto and then, stirred to prepare a positive electrode composition. A content of the dispersion media was 30 parts by weight, based on 100 parts by weight of a solid content. The solid content represents a total of the positive electrode active material, the solid electrolyte, the binder, and the conductive material.

The prepared positive electrode composition was coated by a bar coater on a positive electrode current collector, dried at 80° C. in a convection oven for 10 minutes to form a positive electrode active material layer on the current collector and thus manufacture a positive electrode.

### (5) Manufacture of Negative Electrode

A composition for a negative electrode coating layer was prepared by mixing carbon black with a primary particle diameter (D50) of about 30 nm and silver (Ag) with an average particle diameter (D50) of about 60 nm in a weight ratio of 3:1 to prepare a catalyst and adding 0.25 g of the catalyst to 2 g of an NMP solution including 7 wt % of a polyvinylidene fluoride binder. The composition was bar-coated on a nickel foil current collector and vacuum-dried to form a negative electrode coating layer on the current collector and thus manufacture a precipitation-type negative electrode.

### (6) Manufacture of All-Solid-State Battery Cell

After cutting the positive electrode, the negative electrode, and the solid electrolyte layer, the solid electrolyte layer was stacked on the positive electrode, and the negative electrode was stacked thereon to manufacture an electrode assembly. The electrode assembly was housed in the case for a rechargeable lithium battery and then, sealed into a pouch shape and treated with a warm isostatic press (WIP) under 500 MPa at a high temperature of 85° C. for 30 minutes to manufacture an all-solid-state battery cell. In the pressed state, the positive electrode active material layer had a thickness of about 100 μm, the negative electrode coating layer had a thickness of about 7 μm, and the solid electrolyte layer had a thickness of about 60 μm.

### Example 1-2

A polyurethane resin and an all-solid-state battery cell were manufactured in the same manner as in Example 1-1 except that 15 parts by weight of isopropyl myristate was used as a plasticizer.

### Example 1-3

A polyurethane resin and an all-solid-state battery cell were manufactured in the same manner as in Example 1-1 except that 20 parts by weight of isopropyl myristate was used as a plasticizer.

### Example 1-4

A polyurethane resin and an all-solid-state battery cell were manufactured in the same manner as in Example 1-1 except that 25 parts by weight of isopropyl myristate was used as a plasticizer.

### Example 1-5

A polyurethane resin and an all-solid-state battery cell were manufactured in the same manner as in Example 1-1 except that 30 parts by weight of isopropyl myristate was used as a plasticizer.

### Example 1-6

A polyurethane resin and an all-solid-state battery cell were manufactured in the same manner as in Example 1-1 except that the thickness of the first polymer film was changed to 150 μm.

### Example 1-7

A polyurethane resin and an all-solid-state battery cell were manufactured in the same manner as in Example 1-1 except that the thickness of the first polymer film was changed to 250 μm.

### Example 2-1

A polyurethane resin and an all-solid-state battery cell were manufactured in the same manner as in Example 1-1 except that a second polymer film including a second polyurethane resin was further formed on an inner layer of the laminate sheet, as shown below.

The laminate sheet in which the inner layer, a middle layer, and an outer layer were sequentially laminated (a pouch film, manufacturer: Dai Nippon Printing (DNP) Co., Ltd.) was prepared. The composition for a polymer film was respectively cast on the inner and outer layers of the laminate sheet by using a slip casting method, dried at 130° C. for 4 minutes, and allowed to stand at 45° C. for 3 days. Accordingly, a case for a rechargeable lithium battery, in which the first polymer film (a thickness: 100 μm) including the first polyurethane resin (a weight average molecular weight: 78,480 g/mol) on the outer layer of the laminate sheet and the second polymer film (thickness: 100 μm) including a second polyurethane resin (a weight average molecular weight: 78,480 g/mol) on the inner layer of the laminate sheet were formed, was obtained.

### Example 2-2

A polyurethane resin and an all-solid-state battery were manufactured in the same manner as in Example 2-1 except that 15 parts by weight of isopropyl myristate was used as a plasticizer.

### Example 2-3

A polyurethane resin and an all-solid-state battery were manufactured in the same manner as in Example 2-1 except that 20 parts by weight of isopropyl myristate was used as a plasticizer.

### Example 2-4

A polyurethane resin and an all-solid-state battery were manufactured in the same manner as in Example 2-1 except that 25 parts by weight of isopropyl myristate was used as a plasticizer.

### Example 2-5

A polyurethane resin and an all-solid-state battery were manufactured in the same manner as in Example 2-1 except that 30 parts by weight of isopropyl myristate was used as a plasticizer.

### Example 2-6

A polyurethane resin and an all-solid-state battery were manufactured in the same manner as in Example 2-1 except that each thickness of the first polymer film and the second polymer film was changed to 150 μm.

### Example 2-7

A polyurethane resin and an all-solid-state battery were manufactured in the same manner as in Example 2-1 except that each thickness of the first polymer film and the second polymer film was changed to 250 μm.

### Comparative Example 1

An all-solid-state battery cell was manufactured in the same manner as in Example 1 except that the first polymer film was not formed.

### valuation Example 1: Evaluation of Physical Properties of Polymer Film

Each first polymer film of the Examples was evaluated with respect to a friction coefficient, an elongation rate, tensile strength, and a thickness as follows, and the results are shown in Table 1.

For reference, the friction coefficient was evaluated in the state of forming the polymer film on the outer layer of the laminate sheet, but the elongation rate, the tensile strength, and the thickness were evaluated after taking off the polymer film from the outer layer of the laminate sheet.

Friction Coefficient: measured in a static friction coefficient measurement method. Equipment for measuring a static friction coefficient was used to calculate stress where an object started to move by increasing a slope angle.

Elongation Rate (%): measured by using a universal testing machine (Model No. 4466, Instron) according to an ASTM D638 method to measure a point where a specimen was broken after pulling the specimen at a cross head speed of 200 mm/min and calculate an elongation rate (%) as follows.

Elongation rate(%)=length after stretching/initial length×100

Tensile Strength: measured by using a universal testing machine (Model No. Z020, ZwickRoell LP) according to ISO 527.

Thickness: measured by using a thickness meter (Digimatic Thickness Gauge: Mitutoyo Corp.).

TABLE 1

| | | | Tensile | |
|---|---|---|---|---|
| | Friction | Elongation | strength | Thickness |
| | coefficient (μ) | rate (%) | (kgf/mm²) | (μm) |
| Example 1-1, 2-1 | 0.4 | 430 | 330 | 100 |
| Example 1-2, 2-2 | 0.5 | 450 | 460 | 100 |
| Example 1-3, 2-3 | 0.6 | 445 | 430 | 100 |
| Example 1-4, 2-4 | 0.7 | 440 | 380 | 100 |
| Example 1-5, 2-5 | 0.8 | 440 | 390 | 100 |
| Example 1-6, 2-6 | 0.5 | 480 | 410 | 150 |
| Example 1-7, 2-7 | 0.5 | 650 | 450 | 250 |

### Evaluation Example 2: Nail Penetration Test

Each of the all-solid-state battery cells of the Examples and the Comparative Example was fastened with a pressure of 4 MPa and then, charged to SOC 100% at a charge/discharge rate of 0.1 C in a 45° C. chamber, and after removing a fastening plate, a nail penetration experiment was performed under GB/T conditions (a nail with a diameter of 3 mm, a penetration speed of 25 mm/sec). Subsequently, temperature changes of the all-solid-state battery cells were measured to evaluate a heat generation amount, and the results are shown in Table 2.

TABLE 2

| | Heat generation amount during |
|---|---|
| | nail penetration test |
| | (J/g) |
| Example 1-1 | 724 |
| Example 1-2 | 632 |
| Example 1-3 | 541 |
| Example 1-4 | 512 |
| Example 1-5 | 482 |
| Example 1-6 | 544 |
| Example 1-7 | 346 |
| Example 2-1 | 654 |
| Example 2-2 | 531 |
| Example 2-3 | 494 |
| Example 2-4 | 464 |
| Example 2-5 | 443 |
| Example 2-6 | 486 |
| Example 2-7 | 286 |
| Comparative Example 1 | 2786 |

Referring to Table 2, the all-solid-state battery cells of Examples 1-1 to 1-7 using a case having the first polymer film on the outer layer of the laminate sheet, when subjected to a nail penetration test under the conditions of SOC of 100%, a nail diameter of 3 mm, and a penetration speed of 25 mm/sec, exhibited a heat generation amount of 300 J/mol to 750 J/mol. On the other hand, the all-solid-state battery cell of Comparative Example 1 using a case of the laminate sheet having no polymer film, when subjected to a nail penetration test under the same conditions, exhibited a heat generation amount of greater than 2,700 J/g.

This effect is inferred to be equally applied to a semi-solid battery cell, a lithium metal battery cell, or a lithium ion battery cell as well as the all-solid-state battery cell.

Accordingly, the case for a rechargeable lithium battery according to some embodiments, even when internally penetrated by metal foreign substances, etc. from the outside, suppressed a short circuit and heat generation and thus secured safety of the rechargeable lithium battery cells.

On the other hand, the all-solid-state battery cells of Examples 2-1 to 2-7 using a case having the first polymer film on the outer layer of the laminate sheet and simultaneously, further having the second polymer film on the inner layer thereof exhibited a much reduced heat generation amount in the nail penetration test under the same conditions. Accordingly, the synergistic effect of simultaneously having the first polymer film and the second polymer film was higher than the single effect of having the first polymer film.

By way of summation and review, some rechargeable lithium batteries, which may be lithium ion batteries using an electrolyte solution including a flammable organic solvent, could have safety issues such as explosion or fire, when there occurs collision, penetration, or the like. Accordingly, all-solid-state batteries, to which a solid electrolyte may be used instead of the electrolyte solution, have been proposed. Among the rechargeable lithium batteries, the all-solid-state batteries refers to batteries made of all solid materials and particularly, batteries using the solid electrolyte.

The rechargeable lithium batteries may include a case for a rechargeable lithium battery regardless of its shape; and an electrode assembly housed in the case for a rechargeable lithium battery. In addition, the electrode assembly may include a positive electrode, a negative electrode, and an electrolyte interposed between the positive electrode and the negative electrode. If the case for a rechargeable lithium battery were to be internally penetrated by a metal foreign substance (ex: a nail) from the outside, the penetrating metal foreign substance could form an electronic conductive path, though which electricity could flow, and the electrical energy could be converted into thermal energy.

Some embodiments provide for a case for a rechargeable lithium battery capable of suppressing short circuit and heat generation even if metal foreign substances, etc. penetrates the inside of the battery from the outside of the case.

Some embodiments provide for a case for a rechargeable lithium battery including a laminate sheet in which an inner layer, a middle layer, and an outer layer are sequentially laminated; and a first polymer film may be disposed on the outer layer of the laminate sheet and may include a first polyurethane resin.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A case for a rechargeable lithium battery, the case comprising:
a laminate sheet in which an inner layer, a middle layer, and an outer layer are sequentially laminated; and
a first polymer film on the outer layer of the laminate sheet, the first polymer film including a first polyurethane resin.

2. The case as claimed in claim 1, wherein the case further includes a second polymer film on the inner layer of the laminate sheet, the second polymer film including a second polyurethane resin.

3. The case as claimed in claim 1, wherein the first polymer film has a friction coefficient of about 0.4μ to about 0.8μ.

4. The case as claimed in claim 2, wherein the first polymer film and the second polymer film each independently have a friction coefficient of about 0.4μ to about 0.8μ.

5. The case as claimed in claim 1, wherein the first polymer film has an elongation rate of about 200% to about 700%.

6. The case as claimed in claim 2, wherein the first polymer film and the second polymer film each independently have an elongation rate of about 200% to about 700%.

7. The case as claimed in claim 1, wherein the first polymer film has a tensile strength of about 250 kgf/mm² to about 600 kgf/mm².

8. The case as claimed in claim 2, wherein the first polymer film and the second polymer film each independently have a tensile strength of about 250 kgf/mm² to about 600 kgf/mm².

9. The case as claimed in claim 1, wherein the first polymer film has a thickness of about 10 μm to about 300 μm.

10. The case as claimed in claim 2, wherein the first polymer film and the second polymer film each independently have a thickness of about 10 μm to about 300 μm.

11. The case as claimed in claim 1, wherein the first polyurethane resin has a weight average molecular weight of about 10,000 g/mol to about 3,000,000 g/mol.

12. The case as claimed in claim 2, wherein the first polyurethane resin and the second polyurethane resin each independently have a weight average molecular weight of about 10,000 g/mol to about 3,000,000 g/mol.

13. A method of forming a case for a rechargeable lithium battery, the method comprising:
supplying a laminate sheet in which an inner layer, a middle layer, and an outer layer are sequentially laminated; and
forming a polymer film manufactured from a composition for a polymer film including a urethane binder, a curing agent, and a plasticizer on the outer layer of the laminate sheet.

14. The method as claimed in claim 13, wherein a second polymer film manufactured from the composition for a polymer film is formed on the inner layer of the laminate sheet.

15. The method as claimed in claim 13, wherein the composition for the polymer film includes about 1 part to about 30 parts by weight of the plasticizer, based on 100 parts by weight of the urethane binder.

16. The method as claimed in claim 13, wherein the plasticizer includes isopropyl myristate, isopropyl palmitate, isotridecyl isononanoate, 1,2-cyclohexanedicarboxylic acid diisononyl ester, isostearyl palmitate, isostearyl laurate, diisostearyl adipate, diisocetyl sebacate, or a combination thereof.

17. The method as claimed in claim 13, wherein the urethane binder is prepared by polymerizing about 1 to about 10 parts by weight of an isocyanate compound, based on 100 parts by weight of a polyol including about 50 wt % to about 90 wt % of polyether triol, about 5 wt % to about 40 wt % of polyether diol, and about 5 wt % to about 40 wt % of polyester diol.

18. The method as claimed in claim 13, wherein the composition for the polymer film further includes a leveling agent, an antistatic agent, an antioxidant, a catalyst, a retarder, or a combination thereof.

19. A rechargeable lithium battery, comprising:
the case of claim 1; and
an electrode assembly housed in the case.

20. The rechargeable battery as claimed in claim 19, wherein the rechargeable lithium battery is an all-solid-state battery, and a heat generation amount is about 100 J/g to about 1,000 J/g if subjected to a nail penetration test under conditions of SOC of 100%, a nail diameter of 3 mm, and a penetration speed of 25 mm/sec.
